(19) United States
(12) Patent Application Publication
(10) Pub. No.: US 2019/0242437 A1
(43) Pub. Date: Aug. 8, 2019

(54) Dual Concentric Drive Method and Apparatus

(71) Applicants: Damien Powers, Plymouth, MA (US); Robert Bennett, Quincy, MA (US)

(72) Inventors: Damien Powers, Plymouth, MA (US); Robert Bennett, Quincy, MA (US)

(21) Appl. No.: 16/268,036

(22) Filed: Feb. 5, 2019

Related U.S. Application Data
(60) Provisional application No. 62/626,598, filed on Feb. 5, 2018.

(51) Int. Cl. F16D 1/09; F16D 1/05; F16H 57/00

(52) U.S. Cl. CPC F16D 1/09; F16H 57/0025; F16D 1/05

(57) ABSTRACT

A dual bushing and hub assembly for mounting sheaves, sprockets, gears, couplings and similar machine elements on a shaft, wherein two types of tapered bushings are used, the bushings are used within a single hub which is compatible with both bushings. The dual bushing locking screws for tightening the bushings securely in place on the shaft and in the hub bore are both accessible from the same side of the hub.

### BACKGROUND

### 1. Field of Use

The present invention relates to a method and apparatus for mechanical power transmission and position or timing control by means of a belt or chain driven by an arrangement of a shaft and sprocket or pulley in which the shaft is coupled to the sprocket or pulley by means of dual tapered bushings having locking screws accessible from the same side.

### 2. Description of Prior Art (Background)

Typical torques employed in both mechanical power transmission and motion control applications are often such as to cause significant problems with torque transmission between a shaft and any gears, pulleys or sprockets that are intended to be driven by the shaft. Various methods that are employed to achieve the requisite coupling of torque include set screws, pins, keys, flattened shafts, flanged bushings and clamping couplings of various sorts.

Additionally, in power transmission applications employing sufficiently large shafts, tapered bushing assemblies are known for coupling rotating shafts to sprockets so that rotary motion of the shaft may be transmitted to the sprocket. In the power transmission art, the coupling of substantial torque between a shaft and a hub by a bushing gives rise to requirements such as keys, flanges coupled to the exterior face of the sprocket, and/or large surface areas of interface between the bushing and the shaft and hub respectively. The use of large surface areas of interface is based on the proportionality of static friction, for transmission of shear forces, to the contact area between the surfaces. A typical prior art hub and bushing structure is now described with reference to FIGS. 1 and 2.

Numeral 10 designates generally a sprocket or pulley for driving a chain or belt (not shown), the sprocket having an outer surface 12 and a hub 14. The subject of the present prior art discussion is the coupling of torque between a rotatable shaft 20 of constant diameter and hub 14 by means of a bushing 22. In the power transmission art, the coupling of substantial torque between shaft 20 and hub 14 via bushing 22 is commonly accomplished by using keyways machined into interior bore 46 of the bushing and outside diameter 44 of the shaft 20, with a solid square key 48 inserted into the machined spaces. The use of square keys and keyways for obtaining maximum torque is described in ANSI Standard B17.1, Keys and Keyseats, which is incorporated herein by reference. In this way, the torque that may be coupled by means of shear forces exerted on the keyways increases as the size and strength of the key and keyways increase. Alternatively, torque may be transmitted by means of one or more connectors or pins inserted through an annular flange of the bushing and a side face of the hub. When an annular flange is employed, the maximum diameter of the bushing exceeds the inside diameter of the hub.

Referring also to FIG. 2, a cross-sectional view is shown of the prior art sprocket 10 and bushing 22, with the section taken on line 2-2 of FIG. 1. Mating tapered surfaces of the outside 24 of bushing 22 and the inside 26 of hub 14 are shown, while internal, surface 27 of bushing 22 is shown to be straight and parallel with the surface of shaft 20. Bushing 22 is continuous throughout with the exception of a radial slot 28 of sufficient width to permit the bushing to contract during installation and to grip the shaft firmly. Tapered surfaces 24 and 26 of the bushing and hub, respectively, are adapted to slide relative to one another as the sprocket is assembled onto the shaft and the bushing, is secured in place within hub 14 In a power transmission application, the scaling relationships that are known to hold require that the surface area in contact between bushing 22 and hub 14 must increase at least as fast as the torque required to be transmitted.

In order to insert bushing 22 into hub 14 of sprocket 10, a force is required to overcome the sliding friction developed across the entire contact surface area between the bushing and the hub. A similar sliding friction must be overcome to disengage the bushing from the hub. The sliding friction that must be overcome is proportional to the surface area and thus, as discussed above, to the torque capacity of the bushing.

Since the objective of power transmission applications is typically the transmission of a maximal amount of torque for given geometrical and material constraints, it has been, deemed desirable, in the prior art, to maximize the contact surface area (T) between the bushing and hub. This makes it difficult, however, to overcome the frictional hurdles both for insertion and disengagement, of the bushing. Therefore, the prior art teaches that a taper with an included angle of at least 8° (equivalent to a taper angle α=4°) is placed on external surface 24 of bushing 22 and internal surface 26 of hub 14 in order to reduce the difficulty in releasing the bushing. Typically, a threaded hole 76 (shown in FIG. 1) is provided for insertion of a jack-screw so that force may be applied for release of the bushing.

Engagement of the bushing, moreover, requires that both the sliding friction across the contact surface as well as the lateral component due to the taper must be overcome. In, the prior art, this has been accomplished by use of at least two screws 30 and 32, along with matching tapped threading on the hub, for drawing the bushing into the hub. Consequently, clearance must be provided in the placement of the components for tightening the bushing and for removing the bushing using a jackscrew. An additional concern is the square entry of the bushing upon insertion; since the contact surface area is large (scaling ^{˜}T), the bushing is prone to cocking upon insertion if care is not taken in driving the symmetrically placed screws.

Additionally, the scaling relations of the prior art power transmission applications dictate that the annular width w (shown in FIG. 1) of bushing 22 must scale substantially as the bushing face thickness t since t^{˜}T½. The annular width, however, is half the difference between the outer diameter and inner bore of the bushing. Therefore, w^{˜}dp−ds^{˜}γT½−ξT½, where γ and ξ are coefficients of proportionality. The annular width dimension, w, typically scales as T½ in the limit of large torque, which is the limit of interest in prior art power transmission applications. While the foregoing scaling relations are not intended to be definitive or descriptive of all bushings available in the prior art, they are intended to illustrate the nature of design considerations governed primarily by maximizing torque capacity as taught in the power transmission, art.

The problems described above are compounded when it is desired to couple two shafts to a common hub, or decouple the common hub from two shafts. Often, a hub or sprocket is nearly flush mounted on a drive shaft via perpendicular set screws driven through the hub and tightened on the shaft and/or connected via keys and keyways as described above. Thus, often damaging the shaft and/or limiting access for coupling or decoupling the hub.

In addition, permanently attaching hubs to drive shafts precludes phasing or synchronization of drive elements. For example, as discussed in U.S. Pat. No. 6,568,063, and included here by reference, if a shaft is the drive shaft of a stepper motor providing a fixed six degrees of angular rotation per step, and the driven is attached to the hand of a clock, the motion of the clock hand, given equal diameters of drive pulleys, would be six degrees or one discrete increment and can be synchronized with the markings on a clock face. If, however, a clock hand is out of phase, or misaligned, with the clock face markings by approximately four degrees of clockwise rotation, the subsequent six degree steps will continue to be misaligned by four degrees. Realignment, or synchronization, would not be possible with the prior art key/keyway torque transmission assembly.

### BRIEF SUMMARY

In accordance with a preferred embodiment of the present invention, there is provided a method for applying a dual bushing to improve the concentricity of a coupling two shafts and a hub having dual coaxial central bores. Bushing set screws and jack screws are both accessible from the same direction to facilitate attachment and removal, respectively.

The invention is also directed towards a dual concentric, drive assembly for coupling a first shaft having a first shaft diameter and a second shaft having a second shaft diameter to a hub. The assembly includes a hub having, a first interior bore having a first taper angle α₁ and a first hub bore diameter. The hub also includes a second interior bore having a common axis with the first interior bore and a second taper angle α₂ and second hub bore diameter smaller than the first hub bore diameter. The hub includes an interior first hub short slot facing on the first interior bore and an interior first hub threaded long slot facing on the first interior bore and opposite to the interior first hub short slot. Within the second bore, the hub includes an interior second hub short slot facing on the second interior bore and an interior second hub threaded long slot facing on the second interior bore and opposite to the interior second hub short slot. The assembly also includes a bored first external tapered split bushing. The first tapered split bushing is tapered to match the taper of the first bore of the hub. The first tapered bushing includes a threaded slot having a long dimension parallel to the first bushing bore for matching the first hub short slot thereby defining, a first opening for receiving a first set screw from a first direction. The first tapered bushing also includes a tapered bushing short slot opposite the first tapered bushing threaded slot for matching the interior first hub threaded long slot thereby defining a second opening for receiving the first set screw from the first direction.

The assembly also includes a bored second external tapered split bushing. The second tapered split bushing is tapered to match the taper of the second bore of the hub. The second tapered bushing includes a threaded slot having a long dimension parallel to the second bushing bore for matching the second hub short slot thereby defining a second opening for receiving a second set screw from first or same direction as the first set screw. The second tapered bushing also includes a tapered bushing short slot opposite the second tapered bushing threaded slot for matching the interior second hub threaded long slot thereby defining a second opening for receiving the second set screw from the first direction.

### BRIEF DESCRIPTION OF THE DRAWINGS

The subject matter which is, regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a side elevational view of a shaft/sprocket coupling employing a prior art bushing;

FIG. 2 is a cross-sectional of the prior art shaft/sprocket coupling of FIG. 1, the section being taken along line 2-2 of FIG. 1;

FIG. 3 is a top perspective view of the dual concentric drive apparatus in accordance with the present invention;

FIG. 4 is an exploded view of the dual concentric drive apparatus in accordance with the present invention shown in FIG. 1;

FIG. 5A, FIG. 6A, FIG. 7A are top perspective views of the dual concentric drive apparatus components shown in FIG. 4 and illustrate features of the present invention shown in FIG. 1;

FIG. 5B, FIG. 6B, FIG. 7B are top perspective views of the dual concentric drive apparatus components shown in FIG. 4 and illustrate features of the present invention shown in FIG. 1;

FIG. 8 is a cross-sectional view of the dual concentric hub in accordance with the present invention shown in FIG. 1;

FIG. 9 is a top view of the dual concentric hub in accordance with the present invention shown in FIG. 1; and

FIG. 10 is a bottom view of the dual concentric hub in accordance with the present invention shown in FIG. 1.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

Dual concentric bushing hub assembly may be referred to as dual concentric drive apparatus.

If the specification describes something as “exemplary” or an “example,” it should be understood that refers to a nonexclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

In precision position and motion control applications, considerations driving the design of shaft/sprocket couplings may be other than those of maximizing torque, as in the prior art power transmission applications, and, more particularly, may include the precision concentricity of the shaft and sprocket rotation axes and convenience of assembly and disassembly in tight spaces. Precision concentricity may be required to prevent wobble of the driven components and the wear and noise that may result from imperfect balance. Additionally, in motion control applications, it may be desirable to phase or synchronize various elements of a drive train independently of shaft position. Such phasing may be advantageously accomplished in accordance with certain embodiments of the present invention.

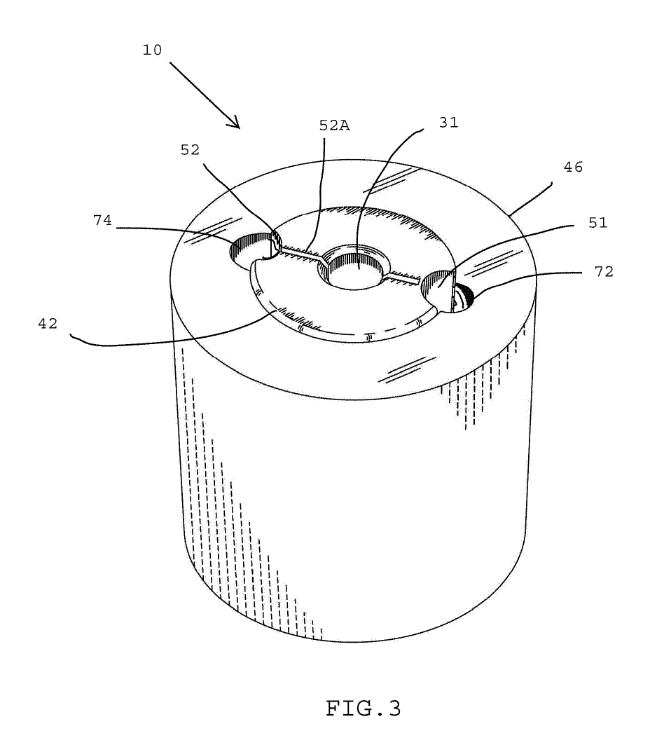

Referring to FIG. 3 there is shown a top perspective view of the dual concentric drive apparatus in accordance with the present invention. Hub 46 with the features described herein may be the hub of any suitable drive mechanism such as a sprocket, pulley, or gear. Bushing 42 is an externally tapered split bushing having an non-tapered bore 31 in accordance with the present invention. Bushing 42 has slit or unthreaded groove 51 which is aligned with slit or threaded groove 72 in hub 46 and forms an opening for driving a set screw (not shown) into said opening for drawing the bushing 42 into hub 46 and frictionally engaging a shaft (not shown) in the non-tapered bore 31.

Still referring to FIG. 3, Bushing 42 has slit or threaded groove 52 which is aligned with slit or non-threaded groove 74 in hub 46 and forms an opening for driving a set screw, often referred to as a jack screw, (not shown) into said opening for drawing the bushing 42 out of hub 46 and disengaging the shaft (not shown) from the non-tapered bore 31. It will be appreciated that threaded groove 52 is along the split 52A, of split bushing 42 facilitating the decoupling of bushing 42 from said shaft and hub 46.

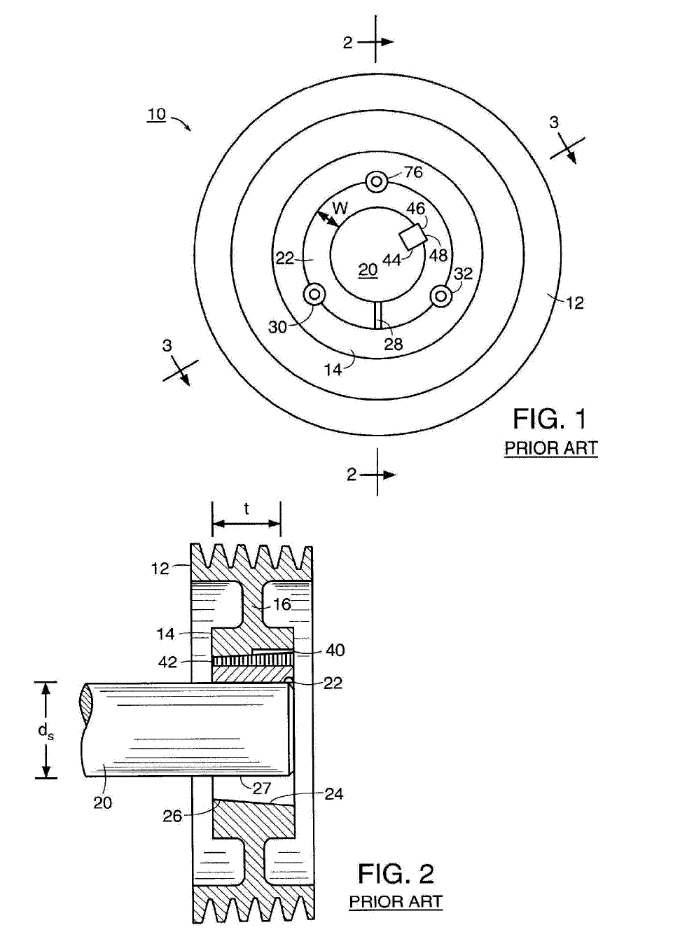

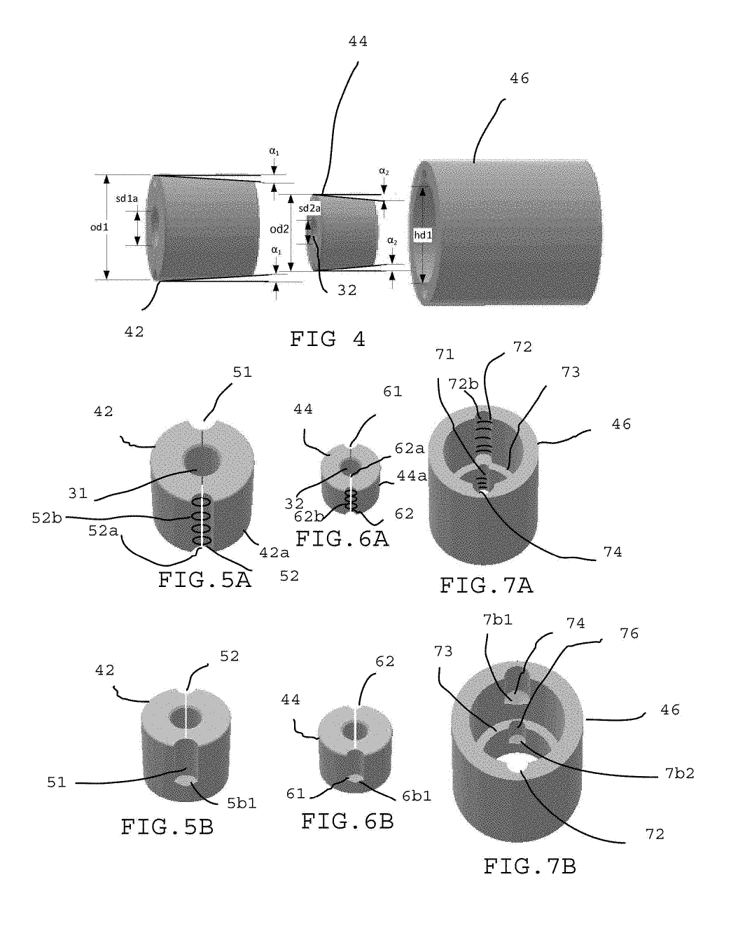

Referring also to FIG. 4 there is shown an exploded view of the dual concentric drive apparatus in accordance with the present invention shown in FIG. 1. Bushing 42, shown in FIG. 3, is a split bushing have an outside diameter od1, an external taper α₁, and a non-tapered bore hole 31 having a diameter sd1a. Bushing 44 is a split bushing have an outside diameter od2, an external taper α₂, and a non-tapered bore hole 32 having a diameter sd2a. Hub 46 has a first bore having an internal diameter hd1 for receiving, bushing 42. As will be described later hub 46 also includes a second bore, coaxial with the first bore, for receiving bushing 44. It will be appreciated that bushing 44 od2 is less than bushing od1.

Referring also to FIG. 5A, FIG. 6A, FIG. 7A there shown top perspective views of the dual concentric drive apparatus components shown in FIG. 4 and illustrate features of the present, invention shown in FIG. 1.

Bushing 42 is a tapered split bushing having a long dimension or groove 52 parallel to the interior bore 31. Groove 52 is split 52a along the entire dimension and threaded 52b. Bushing 42 also includes non-tapered bore 31. Exterior surface 42a may be treated, as by plating, so as to have distinct surface properties from the surface properties of the hub 46 into which bushing 42 is inserted, thereby advantageously reducing the propensity of the bushing to bind upon insertion. Additionally, bushing 42 may be fabricated of a material, such as a metal or a plastic, differing in composition from the material of the hub 46 so as to reduce the propensity of the bushing 42 to bind upon insertion into the hub 46.

Bushing 42 has slit or unthreaded groove 51 which is aligned with slit or threaded groove 72 in hub 46 and forms an opening for driving a set screw (not shown) into said opening for drawing the bushing 42 into hub 46 and frictionally engaging a shaft (not shown) in the non-tapered bore 31.

Bushing 44 is a tapered split bushing, having a long dimension or groove 62 parallel to the interior bore 32. Groove 62 is split 62a along the entire dimension and threaded 62b. Bushing 44 also includes non-tapered bore 32. Exterior surface 44a may be treated, as by plating, so as to have distinct surface properties from the surface properties of the hub 46 into which bushing 44 is inserted, thereby advantageously reducing the propensity of the bushing to bind upon insertion. Additionally, bushing 44 may be fabricated of a material, such as a metal or a plastic, differing in composition from the material of the hub 46 so as to reduce the propensity of the bushing 44 to bind upon insertion into the hub 46.

Additionally bushing 44 has slit or unthreaded groove 61 which is aligned with slit or threaded groove 71 in hub 46 and forms an opening for driving a set screw (not shown) into said opening for drawing the bushing 44 into hub 46 and frictionally engaging a second shaft (not shown) in the non-tapered bore 32.

Hub 46 is a dual, coaxial bore, hub. The bores are sized and tapered to receive bushings 42, 44. Additionally, hub 46 may be fabricated of a material, such as a metal or a plastic, differing in composition from the material of the bushings 42,44 so as to reduce the propensity of the bushings 42, 44 to bind upon insertion into the hub 46.

Referring also to FIG. SB, FIG. 6B, and FIG. 7B there are shown top perspective views of the dual concentric drive apparatus components shown in FIG. 4 and illustrate features of the present invention shown in FIG. 1. Bushings 42 and 44 each include non-threaded slots or grooves 51, 61 for mating with the hub threaded grooves 72, 71 (see FIG. 7A), respectively. It will be appreciated that the non-threaded grooves 51,61 do not extend the length of the bushings and include a termination shelf 5b1, 6b1 for the set screws (not shown) to push against when drawing the bushings into the hub 46.

Hub 46 includes non-threaded slots or grooves 74, 76 for mating with the bushing threaded grooves 52, 62 (see FIGS. 5A, 6A), respectively. It will be appreciated that the non-threaded grooves 74, 76 do not extend the length of the hub and include a termination shelf 7b1,7b2 for the jack screws (not shown) to push against when drawing the bushings out of the hub 46. Also shown in FIG. 7B is shelf 73 indicating where the second bore begins.

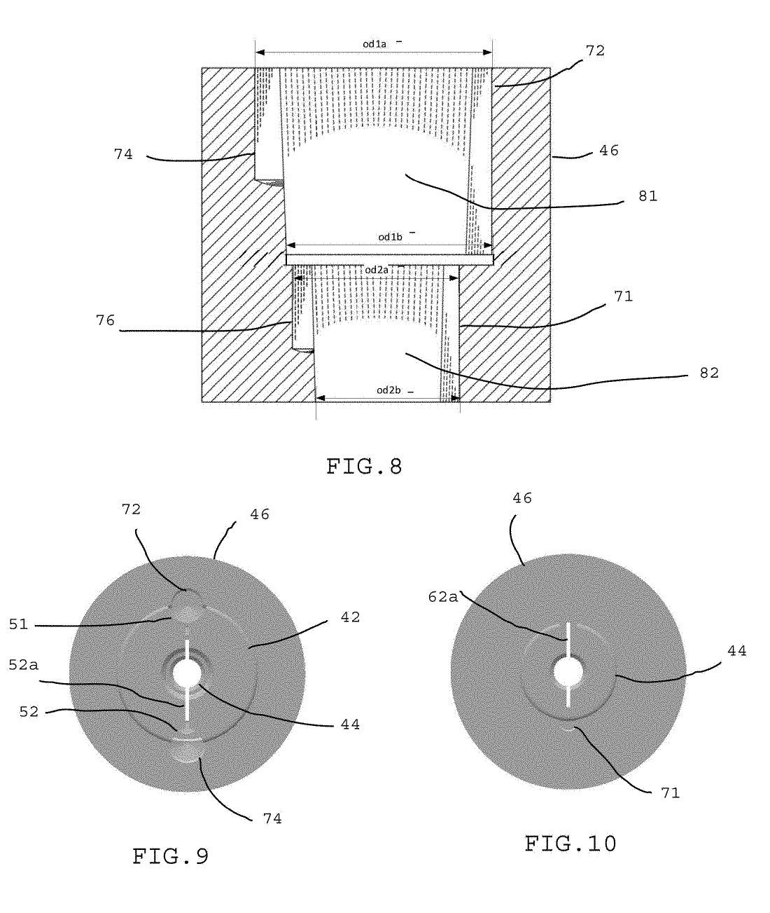

Referring also to FIG. 8 there is shown a cross-sectional view of the hub 46 in accordance with the present invention shown in FIG. 1. Hub 46 includes dual coaxial bores 81, 82. Bore 81 includes diameters od1a, od1b at either end of the bore 81 describing a taper and diameter sized to receive split tapered bushing 42. Bore 82 includes diameters od2a, od2b at either end of the bore 82 describing a taper and diameter sized to receive split tapered bushing 44.

Referring also to FIG. 9 there is shown a top view of the dual concentric bushing hub assembly 10 in accordance with the present invention shown in FIG. 1.

Referring also to FIG. 10 there is shown a bottom view of the dual concentric bushing hub in accordance with the present invention shown in FIG. 1.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims.

What is claimed is:

1. A dual concentric drive apparatus for coupling a first shaft having a first shaft diameter and a second shaft having a second shaft diameter to a hub, the apparatus comprising:
the hub comprising;
a first interior bore comprising a first taper angle α₁ and a first hub bore diameter;
a second interior bore comprising a common axis with the first interior bore and comprising a second taper angle α₂ and a second hub bore diameter smaller than the first hub bore diameter;
an interior first hub short slot facing on the first interior bore;
an interior first hub threaded long slot facing on the first interior bore and opposite to the interior first hub short slot;
an interior second hub short slot facing on the second interior bore; and
an interior second hub threaded long slot facing on the second interior bore and opposite to the interior second hub short slot.

2. The dual concentric drive apparatus as in claim 1 further comprising a first tapered split bushing having a first bushing bore, wherein the first tapered split bushing comprises:
the first hub bore diameter
the first taper angle α₁;
a first inner bore comprising a first inner diameter for receiving the first shaft and maintaining a friction holding force between the first tapered bushing and the first shaft;
a first tapered bushing threaded slot having a long dimension parallel to the first bushing bore for matching the first hub short slot thereby defining a first opening for receiving a first set screw from a first direction; and
a first tapered bushing short slot opposite the first tapered bushing threaded slot for matching the interior first hub threaded long slot thereby defining a second opening for receiving the first set screw from the first direction.

3. The dual concentric drive apparatus as in claim 2 further comprising the first opening having a first opening diameter and the second opening having a second opening diameter, wherein the second opening diameter is less than the first opening diameter.

4. The dual concentric drive apparatus as in claim 1 further comprising a second tapered split bushing having a second bushing bore, wherein the second tapered split, bushing, comprises:
the second hub bore diameter
the second taper angle α₂;
a second inner bore comprising a second inner diameter for receiving the second shaft and maintaining a friction holding force between the second tapered bushing and the second shaft;
a second tapered bushing threaded slot having a long dimension parallel to the second bushing bore for matching the second hub short slot thereby defining a third opening for receiving a second set screw from the first direction; and
a second tapered bushing short slot opposite the second tapered bushing threaded slot for matching the interior second hub threaded long slot thereby defining a fourth opening for receiving the second set screw from the first direction.

5. The dual concentric drive apparatus as in claim 4 further comprising the third opening having a third opening diameter and the fourth opening having a fourth opening diameter, wherein the fourth opening diameter is less than the first opening diameter.

6. A method for coupling a first shaft and a second shaft to a common hub having a coaxial first central bore and a second central bore, the method comprising:
providing a first split bushing having a first interior bore for surrounding the first shaft, and a tapered non-grooved external surface for transferring torque to the hub entirely by friction inside the first central bore, and one first exterior slot in a direction parallel to the first interior bore for matching a first threaded slot in the hub, thereby defining an opening for receiving a first set screw from a first direction;
driving the first set screw into the matched first exterior slot and the first threaded slot such as to draw the first split bushing into the first central bore of the hub, thereby coupling the first shaft to the hub;
providing a second split bushing having a second interior bore for surrounding the second shaft, and a tapered non-grooved external surface for transferring torque to the hub entirely by friction inside the second central bore, and one second exterior slot in a direction parallel to the second interior bore for matching a second threaded slot in the hub, thereby defining an opening for receiving a second set screw from the first direction; and
driving the second set screw into the matched second exterior slot and the second threaded slot from the first direction such as to draw the second split bushing into the second central bore of the hub, thereby coupling the second shaft to the hub.

7. The method as in claim 6 further comprising decoupling the first shaft from the common hub, the method comprising:
providing the first split bushing with an exterior threaded slot in a direction parallel to the first interior bore and opposite the first exterior slot for matching a non-threaded slot in the hub, thereby defining an opening for receiving the first set screw from the first direction; and
driving the first set screw into the matched exterior threaded slot and the non-threaded slot from the first direction such as to draw the first split bushing out of the first central bore of the hub, thereby decoupling the first shaft from the hub.

8. The method as in claim 6 further comprising decoupling the second shaft from the common hub, the method comprising:
providing the second split bushing with an exterior threaded slot in a direction parallel to the second interior bore and opposite the second exterior slot for matching a non-threaded slot in the hub, thereby defining an opening for receiving the second set screw from the first direction; and
driving the second set screw into the matched exterior threaded slot and the non threaded slot from the first direction such as to draw the second split bushing out of the second central bore of the hub, thereby decoupling the second shaft from the hub.

9. A dual concentric drive apparatus for coupling a first shaft having a first shaft diameter and a second shaft having a second shaft diameter to a hub, the apparatus comprising:
the hub comprising;
a first interior bore comprising a first taper angle α₁ and a first hub bore diameter;
a second interior bore comprising a common axis with the first interior bore and comprising a second taper angle α₂ and a second hub bore diameter smaller than the first hub bore diameter;
an interior first hub short slot facing, on the first interior bore;
an interior first hub threaded long slot facing on the first interior bore and opposite to the interior first hub short slot;
an interior second hub short slot facing on the second interior bore; and
an interior second hub threaded long slot facing on the second interior bore and opposite to the interior second hub short slot.
a first tapered split bushing having a first bushing bore, wherein the first tapered split bushing comprises:
the first hub bore diameter
the first taper angle α₁;
a first inner bore comprising a first, inner diameter for receiving the first shaft and maintaining a friction holding force between the first tapered bushing and the first shaft;
a first tapered bushing threaded slot having a long dimension parallel to the first bushing bore for matching the first hub short slot thereby defining a first opening for receiving a first set screw from a first direction; and
a first tapered bushing short slot opposite the first tapered bushing threaded slot for matching the interior first hub threaded long slot thereby defining a second opening for receiving the first set screw from the first direction.
a second tapered split bushing having a second bushing bore, wherein the second tapered split bushing comprises:
the second hub bore diameter
the second taper angle α₂;
a second inner bore comprising a second inner diameter for receiving the second shaft and maintaining a friction holding force between the second tapered bushing and the second shaft;
a second tapered bushing threaded slot having a long dimension parallel to the second bushing bore for matching the second hub short slot thereby defining a third opening for receiving a second set screw from the first direction; and
a second tapered bushing short slot opposite the second tapered bushing threaded slot for matching the interior second hub threaded long slot thereby defining a fourth opening for receiving the second set screw from the first direction.

10. The dual concentric drive apparatus as in claim 9 wherein the first inner bore is not tapered.

11. The dual concentric drive apparatus as in claim 9 wherein the second inner bore is not tapered.
